(19) United States
(12) Patent Application Publication
(10) Pub. No.: US 2026/0326824 A1
(43) Pub. Date: Oct. 22, 2026

(54) MOBILE TRANSPORT SYSTEM

(71) Applicant: SEW-EURODRIVE GMBH & CO. KG, Bruchsal (DE)

(72) Inventors: Friedrich MANZ, Kraichtal-Münzesheim (DE); Joshua Gordon David FRISCH, Hambrücken (DE); Bastian FREITAG, Brühl (DE)

(21) Appl. No.: 19/138,388

(22) PCT Filed: Nov. 15, 2023
(86) PCT No.: PCT/EP2023/081965

§ 371 Date: Jul. 9, 2026

(30) Foreign Application Priority Data
Dec. 12, 2022 (DE) 10 2022 004 673.3

(51) Int. Cl. B62D 24/00; B62D 63/04

(52) U.S. Cl. CPC B62D 24/00; B62D 63/04

(57) ABSTRACT

A mobile transport system for transporting objects in a technical system includes a vehicle frame and a drive module, which has a first drive wheel, which can be rotated about a first drive axle, a second drive wheel, which can be rotated about a second drive axle, and at least one electric motor for driving the drive wheels. The drive module is attached to the vehicle frame via an exchange module, which includes a main plate and a carrier plate. The main plate is fastened to the vehicle frame, and the carrier plate is fastened to the drive module. When the exchange module is in a locked state, the carrier plate is fixedly connected to the main plate, and, when the exchange module is in a released state, the carrier plate is removed from the main plate.

### FIELD OF THE INVENTION

The present invention relates to a mobile transport system for transporting objects in a technical system, including, for example, a vehicle frame and a drive module which has a first drive wheel, which can be rotated about a first drive axle, a second drive wheel, which can be rotated about a second drive axle, and at least one electric motor for driving the drive wheels.

### BACKGROUND INFORMATION

In technical systems, for example, in production plants or painting systems, mobile transport systems, in particular, autonomous mobile transport systems, are used to transport objects such as small parts or crates. Among other things, these mobile transport systems bring components from logistics areas, such as a materials warehouse, to workplaces where the components are processed. Generic mobile transportation systems are capable of overcoming slight inclines or declines as well as small ground sills or similar obstacles.

A mobile transport system for transporting objects, which includes a vehicle frame, a swing frame which can pivot about a swing axis relative to the vehicle frame, and a drive unit, is described in German Patent Document No. 10 2021 000 838. The drive unit is arranged on the swing frame.

A mobile transport system for transporting objects is also described in German Patent Document No. 10 2020 007 712. The mobile transportation system includes a vehicle frame, a first pair of wheels, a second pair of wheels, and a third pair of wheels, each with two wheels, and a swing frame which can be pivoted relative to the vehicle frame. The wheels of the second pair of wheels are arranged as drive wheels and can be driven by a drive unit.

For maintenance and repair of a mobile transport system, it is often necessary to remove the drive module with the drive wheels from the vehicle frame. Due to the configuration of certain conventional mobile transportation systems, removing the drive module from the vehicle frame is relatively complex.

### SUMMARY

Example embodiments of the present invention provide a mobile transportation system for transporting objects.

According to example embodiments, a mobile transport system for transporting objects in a technical system includes a vehicle frame and a drive module, which has a first drive wheel, which can be rotated about a first drive axle, a second drive wheel, which can be rotated about a second drive axle, and at least one electric motor for driving the drive wheels. The drive module is attached to the vehicle frame via an exchange module, the exchange module includes a main plate and a carrier plate, the main plate is fastened to the vehicle frame, and the carrier plate is fastened to the drive module. In a locked state of the exchange module, the carrier plate is fixedly connected to the main plate, and when the exchange module is in a released state, the carrier plate is removed from the main plate.

In the mobile transport system described herein, the drive module is relatively readily removed from the vehicle frame for maintenance and repair. A defective drive module is also relatively readily replaceable. When the exchange module is brought into the released state, the carrier plate is removed from the main plate and the drive module can thus be released from the vehicle frame.

According to example embodiments, the exchange module includes a first transverse block and a second transverse block. In the locked state of the exchange module, the first transverse block is screwed to the main plate via at least one first main screw, the first transverse block is screwed to the carrier plate via at least one first carrier screw, the second transverse block is screwed to the main plate via at least one second main screw, and the second transverse block is screwed to the carrier plate via at least one second carrier screw. By releasing the at least one main screw on a first side of the mobile transport system and releasing the at least one carrier screw on a second side of the mobile transport system, the drive module can be removed from the vehicle frame in the transverse direction either on the first side or on the second side.

According to example embodiments, in the locked state of the exchange module, the first transverse block is arranged on a first edge region of the main plate, and the second transverse block is arranged on a second edge region of the main plate. The first edge region is opposite the second edge region in the transverse direction.

According to example embodiments, the carrier plate includes a first centering pin and a second centering pin. The first transverse block has a first centering opening, the second transverse block has a second centering opening, and in the locked state of the exchange module, the first centering pin projects into the first centering opening, and the second centering pin projects into the second centering opening. The centering pins and centering openings allow the carrier plate and the main plate to be centered when the exchange module is brought back to the locked state, i.e., when the drive module is connected to the vehicle frame.

According to example embodiments, the exchange module includes at least one first locking pin, which projects through the first transverse block, and at least one second locking pin, which projects through the second transverse block. In the locked state of the exchange module, the locking pins project into bores of the main plate, and the locking pins can be moved out of the bores of the main plate against a spring force. The locking pins prevent unintentional movement of the drive module relative to the vehicle frame while the exchange module is being brought from the locked state to the released state.

According to example embodiments, the locking pins can be moved against the spring force in the vertical direction relative to the transverse blocks out of the bores of the main plate.

According to example embodiments, the drive module includes a swing frame which is pivotable relative to the carrier plate about a swing axis extending in the transverse direction, and the drive wheels are arranged on the swing frame and can be rotated relative to the swing frame. In this manner, all the wheels of the mobile transport system are always in contact with the ground, even when driving on an incline or decline.

According to example embodiments, the drive module includes a tilting frame, which is pivotable relative to the swing frame about a tilting axis extending at least approximately in the longitudinal direction, and the drive module includes a first front support wheel and a second front support wheel, which are arranged on the tilting frame. In this manner, all the wheels of the mobile transport system are always in contact with the ground, even when driving on a slope that rises or falls to the side.

According to example embodiments, the front support wheels are each pivotable relative to the tilting frame about a pivot axis extending in the vertical direction and rotatable relative to the tilting frame about a pivot axis extending in a horizontal direction. Support wheels arranged in this manner are relatively inexpensive and also make it possible for the mobile transport system to negotiate bends.

According to example embodiments, the mobile transport system includes a first rear support wheel and a second rear support wheel, which are arranged on the vehicle frame, and the rear support wheels are each pivotable relative to the vehicle frame about a pivot axis extending in the vertical direction and rotatable relative to the vehicle frame about a pivot axis extending in a horizontal direction. Support wheels arranged in this manner are relatively inexpensive and also make it possible for the mobile transport system to negotiate bends.

Further features and aspects of example embodiments of the present invention are explained in more detail below with reference to the appended schematic Figures.

### BRIEF DESCRIPTION OF THE DRAWINGS

FIG. 1 is a side view of a part of a mobile transportation system.

FIG. 2 is a perspective view of a drive module with an exchange module.

FIG. 3 illustrates an exchange module in a released state.

### DETAILED DESCRIPTION

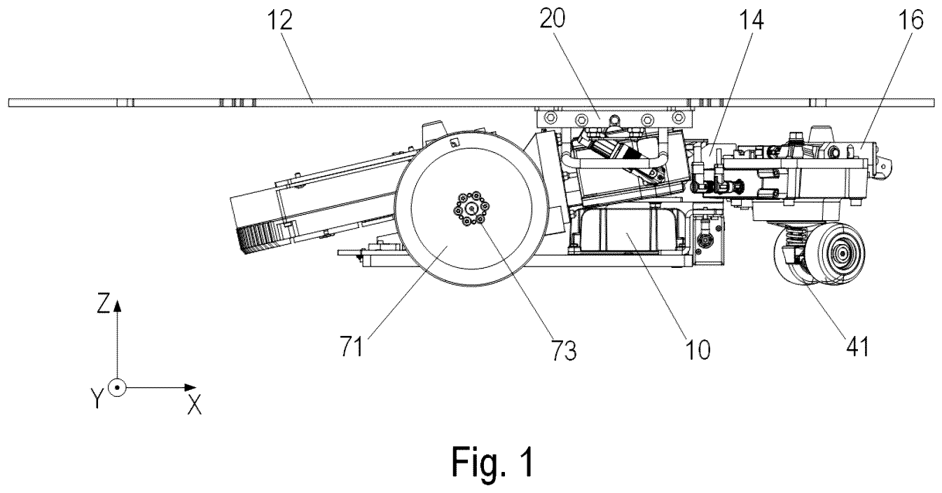

FIG. 1 is a side view of a part of a mobile transportation system. The mobile transport system is used, for example, to transport objects within a technical facility. The technical system is an industrial application, for example, a production plant or painting system. For example, the mobile transport system is an autonomous driving vehicle. As illustrated, the mobile transport system is located on a flat ground within the technical system.

The mobile transport system 10 includes a vehicle frame 12 and a drive module 10. The mobile transport system 10 further includes an exchange module 20. The drive module 10 is attached to the vehicle frame 12 via the exchange module 20. The vehicle frame 12 has an approximately rectangular cross-section and extends predominantly in a longitudinal direction X and in a transverse direction Y.

The mobile transport system also includes a first rear support wheel and a second rear support wheel. The rear support wheels are arranged on the vehicle frame 12. The rear support wheels are each pivotable relative to the vehicle frame 12 about a pivot axis extending in the vertical direction Z and rotatable relative to the vehicle frame 12 about an axis of rotation extending in a horizontal direction. The rear support wheels are arranged offset to each other in the transverse direction Y.

Depending on a pivoting of the rear support wheels about the pivot axis, the axes of rotation of the rear support wheels extend, for example, in the longitudinal direction X or in the transverse direction or in another horizontal direction. The pivot axis and the axis of rotation of a rear support wheel do not intersect in the present example embodiment. The rear support wheels each include two rollers, which are arranged parallel to each other. A braking device is fitted to each of the rear support wheels. Via the braking device, a rotation of the respective rear support wheel around the axis of rotation can be braked. For example, the braking devices can be actuated electromagnetically.

For example, the longitudinal direction X corresponds at least approximately to the usual direction of travel of the mobile transport system. The transverse direction Y extends at a right angle to the longitudinal direction X. The longitudinal direction X and the transverse direction Y represent horizontal directions and extend parallel to the flat ground on which the mobile transport system is located. The vertical direction Z is perpendicular to the flat ground and, thus, extends at a right angle to the longitudinal direction X and at a right angle to the transverse direction Y. Each direction at a right angle to the vertical direction Z represents a horizontal direction.

The drive module 10 has a first drive wheel 71 which can be rotated about a first drive axle 72 and a second drive wheel 72 which can be rotated about a second drive axle 74. The drive wheels 71, 72 are arranged offset from each other in the transverse direction Y. The first drive wheel 71 is located on a first side of the mobile transport system in the transverse direction Y. The second drive wheel 72 is located on a second side of the mobile transport system in the transverse direction Y.

The drive module 10 also has an electric motor for driving the first drive wheel 71 and an electric motor for driving the second drive wheel 72. The first drive axle 72 and the second drive axle 74 extend in the transverse direction Y and are aligned with each other. The drive module 10 also includes a control unit for controlling the electric motors for driving the drive wheels 71, 72.

The drive module 10 includes a swing frame 14. The swing frame 14 can be pivoted about a swing axis relative to the vehicle frame 12. The swing axis extends in the transverse direction Y. The drive wheels 71, 72 are arranged on the swing frame 14 and can be rotated relative to the swing frame 14. The electric motors for driving the drive wheels 71, 72 are also arranged on the swing frame 14.

The drive module 10 includes a tilting frame 16. The tilting frame 16 can be pivoted about a tilting axis relative to the swing frame 14. The tilting axis extends at least approximately in the longitudinal direction X. If the swing frame 14 is pivoted about the swing axis relative to the vehicle frame 12, the tilting axis extends at a slight angle to the longitudinal direction X. However, this inclination of the tilting axis is relatively slight. For example, the tilting axis, thus, still extends approximately in the longitudinal direction X.

The drive module 10 includes a first front support wheel 41 and a second front support wheel 42. The front support wheels 41 are arranged on the tilting frame 16. The front support wheels 41, 42 are each pivotable relative to the tilting frame 16 about a pivot axis extending in the vertical direction Z and rotatable relative to the tilting frame 16 about an axis of rotation extending in a horizontal direction. The front support wheels 41, 42 are arranged offset from each other in the transverse direction Y.

Depending on a pivoting of the front support wheels 41, 42 about the pivot axis, the axes of rotation of the front support wheels 41, 42 extend, for example, in the longitudinal direction X or in the transverse direction or in another horizontal direction. The pivot axis and the axis of rotation of a front support wheel 41, 42 do not intersect in the present example embodiment. The front support wheels 41, 42 each include two rollers, which are arranged parallel to each other. A braking device is arranged on each of the front support wheels 41, 42. The braking device can be used to brake a rotation of the respective front support wheel 41, 42 about the axis of rotation. For example, the braking devices can be actuated electromagnetically.

The drive wheels 71, 72 are arranged in the longitudinal direction X between the rear support wheels and the front support wheels 41, 42. A distance between the drive wheels 71, 72 in the transverse direction Y is greater than a distance between the front support wheels 41, 42 in the transverse direction Y. A distance between the drive wheels 71, 72 in the transverse direction Y is also greater than a distance between the rear support wheels in the transverse direction Y. The drive wheels 71, 72, the front support wheels 41, 42 and the rear support wheels are arranged, for example, in the form of a hexagon, which is symmetrical to a longitudinal axis extending in the longitudinal direction X.

The mobile transport system has an electrical energy storage device. The mobile transport system also has a receiver unit, which is arranged on the swing frame 14 and to which energy can be transferred inductively from a charging unit. The charging unit is arranged as a linear conductor or coil, for example. The energy transmitted inductively from the charging unit to the receiver unit is used, for example, to charge the electrical energy storage device. The receiver unit is located between the drive wheels 71, 72, for example.

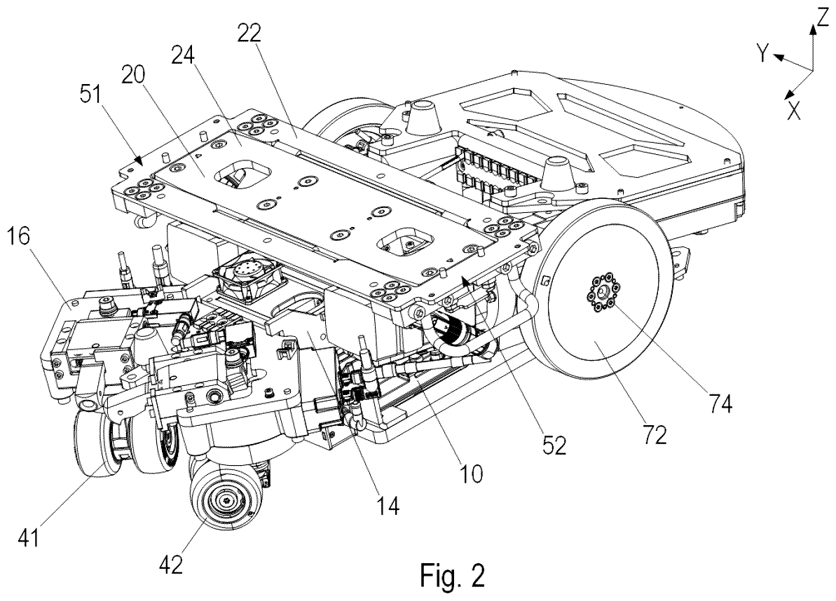

FIG. 2 is a perspective view of a drive module 10 with an exchange module 20. The exchange module 20 includes a main plate 22 and a carrier plate 24. The main plate 22 is fastened to the vehicle frame 12. The carrier plate 24 is fastened to the drive module 10. The swing frame 14 can thus be pivoted relative to the carrier plate 24 about the swing axis extending in the transverse direction Y.

The exchange module 20 is illustrated in a locked state. In the locked state of the exchange module 20, the carrier plate 24 is fixedly connected to the main plate 22. Thus, in the locked state of the exchange module 20, the drive module 10 is fixedly connected to the vehicle frame 12.

The main plate 22 has a first edge region 51 and a second edge region 52. The first edge region 51 is opposite the second edge region 52 in the transverse direction Y. In the locked state of the exchange module 20, the carrier plate 24 is located completely or at least almost completely between the edge regions 51, 52 of the main plate 22 in the transverse direction Y. The first edge region 51 is arranged adjacent to the first drive wheel 71, the second edge region 52 is arranged adjacent to the second drive wheel 72.

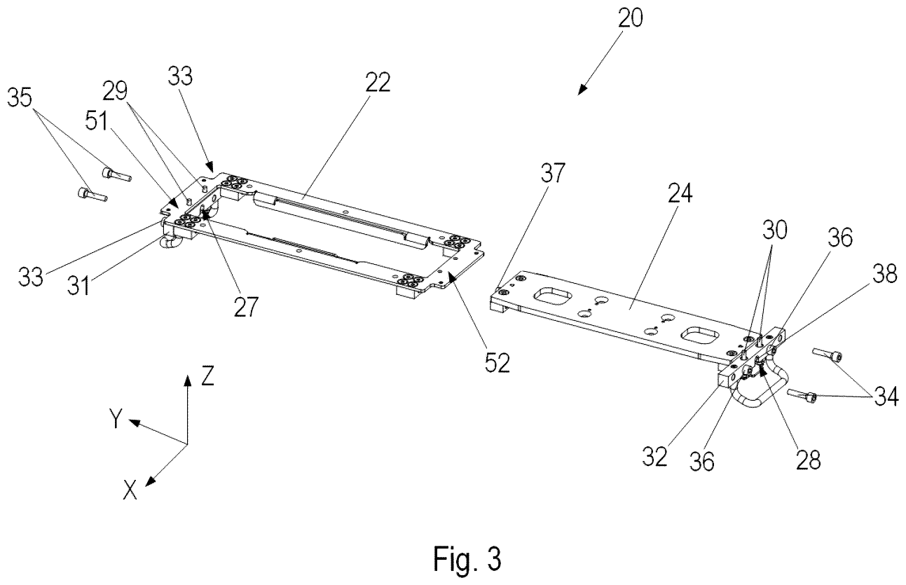

FIG. 3 illustrates an exchange module 20 in a released state. In the released state of the exchange module 20, the carrier plate 24 is removed from the main plate 22. In this manner, the drive module 10 can be detached from the vehicle frame 12 when the exchange module 20 is released. The carrier plate 24 is illustrated removed from the main plate 22 in the vertical direction Z and in the transverse direction Y.

The exchange module 20 includes a first transverse block 31 and a second transverse block 32. In the locked state of the exchange module 20, the first transverse block 31 is arranged on the first edge region 51 of the main plate 22, and the second transverse block 32 is arranged on the second edge region 52 of the main plate 22. As illustrated, in the released state of the exchange module 20, the second transverse block 32 is removed from the second edge region 52 of the main plate 22.

In the locked state of the exchange module 20, the first transverse block 31 is screwed to the main plate 22 via two first main screws 33, and the second transverse block 32 is screwed to the main plate 22 via two second main screws 34. The main plate 22 includes threaded blocks into which the first main screws 33 and the second main screws 34 are screwed.

In the locked state of the exchange module 20, the first transverse block 31 is screwed to the carrier plate 24 via two first carrier screws 35, and the second transverse block 32 is screwed to the carrier plate 24 via two second carrier screws 36. The carrier plate 24 includes threaded blocks into which the first carrier screws 35 and the second carrier screws 36 are screwed.

In the locked state of the exchange module 20, the two first carrier screws 35 are arranged in the longitudinal direction X between the two first main screws 33, and the two second carrier screws 36 are arranged in the longitudinal direction X between the two second main screws 34.

As illustrated, in the released state of the exchange module 20, the first transverse block 31 is screwed to the main plate 22 via the first main screws 33, and the second transverse block 32 is screwed to the carrier plate 24 via the second carrier screws 36. The first carrier screws 35 and the second main screws 34 are released. The first transverse block 31 is, thus, released from the carrier plate 24, and the second transverse block 32 is released from the main plate 22.

The first transverse block 31 has a first centering opening 27. The carrier plate 24 includes a first centering pin 37. In the locked state of the exchange module 20, the first centering pin 37 projects into the first centering opening 27. The second transverse block 32 has a second centering opening 28. The carrier plate 24 includes a second centering pin 38. In the locked state of the exchange module 20, the second centering pin 38 projects into the second centering opening 28. The first centering pin 37 and the second centering pin 38 are arranged opposite each other in the transverse direction Y.

The exchange module 20 includes two first locking pins 29, which project through the first transverse block 31. The exchange module 20 includes two second locking pins 30, which project through the second transverse block 32. In the locked state of the exchange module 20, the locking pins 29, 30 project into bores of the main plate 22. The locking pins 29, 30 can be moved against a spring force in the vertical direction Z relative to the transverse blocks 31, 32 out of the bores of the main plate 22.

When the mobile transport system is in operation, the exchange module 20 is in the locked state, as illustrated in FIG. 1 and FIG. 2. The carrier plate 24 is fixedly connected to the main plate 22, and the drive module 10 is fixedly connected to the vehicle frame 12.

To remove the drive module 10 with the drive wheels 71, 72 from the vehicle frame 12, the exchange module 20 is brought into the released state, as illustrated, for example, in FIG. 3. The exchange module 20 allows the drive module 10 to be removed from the vehicle frame 12 either on the first side, on which the first drive wheel 71 is located, or on the second side, on which the second drive wheel 72 is located.

In order to remove the drive module 10 from the vehicle frame 12 on the second side, as illustrated in FIG. 3, the first carrier screws 35 and the second main screws 34 are first released. This releases the first transverse block 31 from the carrier plate 24, and the second transverse block 32 is released from the main plate 22.

The vehicle frame 12 is raised in the vertical direction Z relative to the drive module 10. This causes the carrier plate 24 to move away from the main plate 22 in the vertical direction Z. If necessary, the locking pins 29, 30 are moved out of the bores of the main plate 22. The exchange module 20 is, thus, in the released state. The drive module 10 is removed from the vehicle frame 12 on the second side in the transverse direction Y.

To subsequently reconnect a drive module 10 to the vehicle frame 12, the drive module 10 is first pushed under the vehicle frame 12 in the transverse direction Y from the second side. If necessary, the locking pins 29, 30 are pulled downwards in the vertical direction Z, i.e., towards the floor.

The vehicle frame 12 is lowered in the vertical direction Z relative to the drive module 10. This brings the carrier plate 24 closer to the main plate 22 in the vertical direction Z.

The locking pins 29, 30 engage in the bores of the main plate 22. The centering pins 37, 38 also engage in the centering openings 27, 28.

The first transverse block 31 is screwed to the carrier plate 24 using the previously released first carrier screws 35. The second transverse block 32 is also screwed to the main plate 22 using the previously released second main screws 34. The exchange module 20 is in the locked state again.

To remove the drive module 10 from the vehicle frame 12 on the first side, the second carrier screws 36 and the first main screws 33 are first released. This releases the first transverse block 31 from the main plate 22 and the second transverse block 32 from the carrier plate 24. The further steps correspond to the steps described above for removing the drive module 10 from the vehicle frame 12 on the second side.

### LIST OF REFERENCE NUMERALS

10 Drive module
12 Vehicle frame
14 Swing frame
16 Tilting frame
20 Exchange module
22 Main plate
24 Carrier plate
27 First centering opening
28 Second centering opening
29 First locking pin
30 Second locking pin
31 First transverse block
32 Second transverse block
33 First main screw
34 Second main screw
35 First carrier screw
36 Second carrier screw
37 First centering pin
38 Second centering pin
41 First front support wheel
42 Second front support wheel
51 First edge region
52 Second edge region
71 First drive wheel
72 Second drive wheel
73 First drive axle
74 Second drive axle
X Longitudinal direction
Y Transverse direction
Z Vertical direction

1-10. (canceled)

11. A mobile transport system for transporting objects in a technical system, comprising:
a vehicle frame;
a drive module including a first drive wheel rotatable about a first drive axle, a second drive wheel rotatable about a second drive axle, and at least one electric motor adapted to drive the drive wheels; and
an exchange module attaching the drive module to the vehicle frame and including a main plate fastened to the vehicle frame and a carrier plate fastened to the drive module;
wherein, in a locked state of the exchange module, the carrier plate is fixedly connected to the main plate, and, in a released state of the exchange module, the carrier plate is removed from the main plate.

12. The mobile transport system according to claim 11, wherein the exchange module includes a first transverse block and a second transverse block, in the locked state of the exchange module, the first transverse block is screw-connected to the main plate via at least one first main screw, the first transverse block is screw-connected to the carrier plate via at least one first carrier screw, the second transverse block is screw-connected to the main plate via at least one second main screw, and the second transverse block is screw-connected to the carrier plate via at least one second carrier screw.

13. The mobile transport system according to claim 12, wherein, in the locked state of the exchange module, the first transverse block is arranged on a first edge region of the main plate, and the second transverse block is arranged at a second edge region of the main plate, the first edge region being opposite the second edge region in a transverse direction.

14. The mobile transport system according to claim 12, wherein the carrier plate includes a first centering pin and a second centering pin, the first transverse block includes a first centering opening, the second transverse block includes a second centering opening, in the locked state of the exchange module, the first centering pin projecting into the first centering opening and the second centering pin projecting into the second centering opening.

15. The mobile transport system according to claim 12, wherein the exchange module includes at least one first locking pin projecting through the first transverse block and at least one second locking pin projecting through the second transverse block, in the locked state of the exchange module, the locking pins projecting into bores of the main plate, the locking pins being movable against a spring force out of the bores of the main plate.

16. The mobile transport system according to claim 15, wherein the locking pins are movable against the spring force in a vertical direction relative to the transverse blocks out of the bores of the main plate.

17. The mobile transport system according to claim 11, wherein the drive module includes a swing frame pivotable relative to the carrier plate about a swing axis extending in a transverse direction, and the drive wheels are arranged on the swing frame and are rotatable relative to the swing frame.

18. The mobile transport system according to claim 17, wherein the drive module includes a tilting frame pivotable relative to the swing frame about a tilting axis extending at least approximately in a longitudinal direction, the drive module including a first front support wheel and a second front support wheel arranged on the tilting frame.

19. The mobile transport system according to claim 18, wherein the front support wheels are pivotable relative to the tilting frame about a pivot axis extending in a vertical direction and rotatable relative to the tilting frame about an axis of rotation extending in a horizontal direction.

20. The mobile transport system according to claim 11, further comprising a first rear support wheel and a second rear support wheel arranged on the vehicle frame, the rear support wheels being pivotable relative to the vehicle frame about a pivot axis extending in a vertical direction and rotatable relative to the vehicle frame about an axis of rotation extending in a horizontal direction.

21. The mobile transport system according to claim 11, wherein the technical system includes an industrial system, a production system, and/or a painting system.

22. The mobile transport system according to claim 11, wherein the mobile transport system is arranged as an autonomous driving vehicle.

23. The mobile transport system according to claim 11, wherein the vehicle frame has a substantially rectangular cross-section.

24. The mobile transport system according to claim 20, wherein the rear support wheels are arranged offset from each other in a transverse direction.

25. The mobile transport system according to claim 20, wherein the pivot axis and the axis of rotation do not intersect.

26. The mobile transport system according to claim 11, wherein the first drive wheel and the second drive wheel are arranged offset from each other in a transverse direction.

27. The mobile transport system according to claim 11, wherein the first drive wheel is located on a first side of the mobile transport system in a transverse direction, and the second drive wheel is located on a second side of the mobile transport system in the transverse direction.

28. The mobile transport system according to claim 11, wherein the at least one electric motor includes a first electric motor adapted to drive the first drive wheel and a second electric motor adapted to drive the second drive wheel.

29. The mobile transport system according to claim 11, wherein the drive module includes a control unit adapted to control the electric motor to drive the drive wheels.

30. The mobile transport system according to claim 17, wherein the electric motor is arranged on the swing frame.
